(19) United States
(12) Patent Application Publication
(10) Pub. No.: US 2005/0046643 A1
(43) Pub. Date: Mar. 3, 2005

(54) Process for preparing customized posters, banners and trade show graphics

(76) Inventor: Mitch Termotto, Winston-Salem, NC (US)

Correspondence Address: Charles Y. Lackey, PO Box 5871, Winston-Salem, NC, 27113-5871, US

(21) Appl. No.: 10/963,960

(22) Filed: Oct. 14, 2004

Related U.S. Application Data
(63) Continuation of application No. 10/368,034, filed on Feb. 19, 2003.

(51) Int. Cl. G09G 5/00

(52) U.S. Cl. 345/619

(57) ABSTRACT

A process for preparing signage such as posters, banners, trade show graphics and other similar items that permits customization through the use of a selection of background images and on which to be printed. The customer selects an image and customizes with text and/or graphics online using online tools provided on a website. The customer proofs the image online, places an order and the created file is sent to a printing center where the background image is printed with the customer customization.

The present application is a continuation application of my pending patent application Ser. No. 10/368,034 filed Feb. 19, 2003.

### BACKGROUND OF THE INVENTION

1. Field of the Invention

The present invention is directed to a process for preparing customized sinage, and more particularly, to such a process that includes selecting a background media image from an inventory of different media images, selecting text and graphics from an inventory of differing text and graphics, adding the selected text and graphics to the background image to customize the background image, creating a file of the customized background image and sending the file to an imaging center for printing.

2. Description of the Prior Art

Posters and banners advertising or announcing a coming event promoting particular products and services are usually prepared in total by a supplier skilled in developing and producing such materials as a total customized project selecting the materials, background, trim and graphics for the customers' approval or correction. A number of changes are usually requested by the customer which often prompts the supplier to make other changes to make all phases of the project compatible and consistent. This procedure often results in a rather expensive final project particularly when the needed volume of posters or banners is low. The cost of custom printing a small quantity or batch results in the price for such items being substantially greater than the prices of convention non-customized posters or banners.

Partial customization has been done to the extent that printed signage may be prepared for purchase that has some generally used printed messages and blanks and voids that can be completed by the purchaser with more specific and personalized messages. While this technique keeps the price of the posters or banners within reason, the finished product often lacks the professional appearance and graphic specificity desired. Thus there is needed a technique or method of preparing and providing finished signage that will be graphically appealing and attractive without the high cost normally associated with such finished products. It is to that specific need that the present invention is directed.

### BRIEF SUMMARY AND OBJECTIVES OF THE INVENTION

The present invention is directed to a process for preparing signage such as posters, banners, trade show and retail graphics, and other similar items. An inventory of differing background images and finishings and a library of text and graphics images are collected by the supplier and are made available to those customers who have specific or more general needs for such products. The customer can then select the background image it prefers from the inventory, the graphics and text it prefers from the library of images. The supplier can sell the selectively formed sign to a printer or signmaker who will add vinyl or custom graphics for the end user, or customize the desired the background image by adding the selected graphics and text and sell the entire customized sinage product to the end user. In either case, the furnished product is either partially customized with customer-selected graphics and text or fully customized with customer selected graphics and text including some materials furnished by the supplier and other customer-owned graphics or logos. Thus the finished product can be highly visible, professionally prepared and presented, message specific and not necessarily expensive. The background image media can be selected from banner material, adhesive vinyl, canvas, paper, corrugated plastic, foam, and trade show lexan, the image can be selected from full background, ghosted center, fully ghosted and white center, and the finishing can be selected from mount to magnetic, contour cuts, ropes in hems, hems and grommets and pole pockets. The added printed matter and other graphics can be printed with a full color printer.

From the foregoing summary, it can be observed that a primary objective of the present invention is to provide a process for making fully or partially custom designed signage such as posters and banners that can be produced and sold at lower prices usually associated with such products even when produced in small or relatively small volumes.

Another objective of the present invention is to provide a variety of images that can be horizontally or vertically oriented.

Yet another objective of the present invention is to provide a process to make single and double sided light post banners, hanging banners and banners for various kinds of free-standing holders.

Still another objective of the present invention is to provide a process for making small banner quantities at an affordable price and yet make larger quantities at a competitive price.

Yet another further objective of the present invention is to provide a library of images that include textures, seasons, celebrations, food, music, sports and holidays.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention, which is measured by its claims, nor to limit its scope in any way.

Thus, the objects of the invention set forth above, along with the various features of novelty which characterize the invention, are noted with particularity in the claims annexed to and forming a part of this disclosure. For a better understanding of the invention, its operating advantages and the specific results obtained by its use, reference should be made to the following detailed specification taken in conjunction with the accompanying drawings wherein like characters of reference designate like parts throughout the several views.

The drawings are included to provide a further understanding of the invention and are incorporated in and constitute a part of this specification. They illustrate embodiments of the invention and, together with their description, serve to explain the principles of the invention.

### BRIEF DESCRIPTION OF THE DRAWINGS

FIG. 1 is a block diagram of the process of the present invention wherein the supplier produces the entire signage including printed and other graphic material;

FIG. 2 is a block diagram of the process of the present invention wherein the user is the supplier;

FIG. 3 is a block diagram of the process of the present invention wherein the user is the customer;

FIG. 4 is a front elevational view of a single light post banner graphically identifying the dates of an event;

FIG. 5 is a front elevational view of double light post banners suggesting a seasonal and a musical theme;

FIG. 6 is a front elevational view of a wave-shaped banner produced by the method of the invention; and

FIG. 7 is a front elevational view of a banner displaying a baseball theme produced by the method of the present invention.

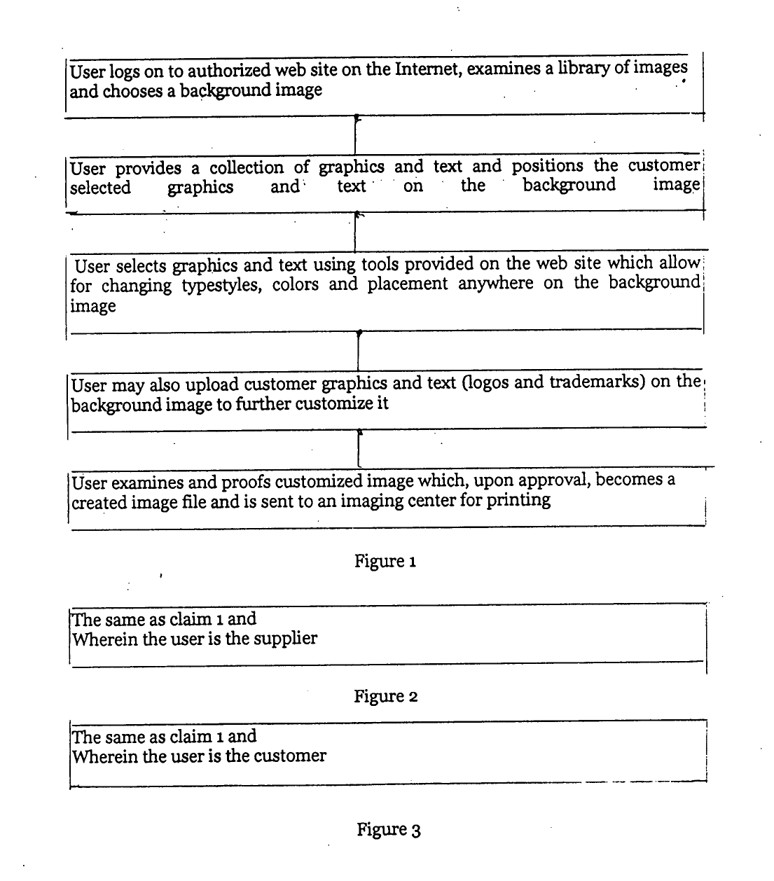

### DETAILED DESCRIPTION OF THE PREFERRED EMBODIMENT

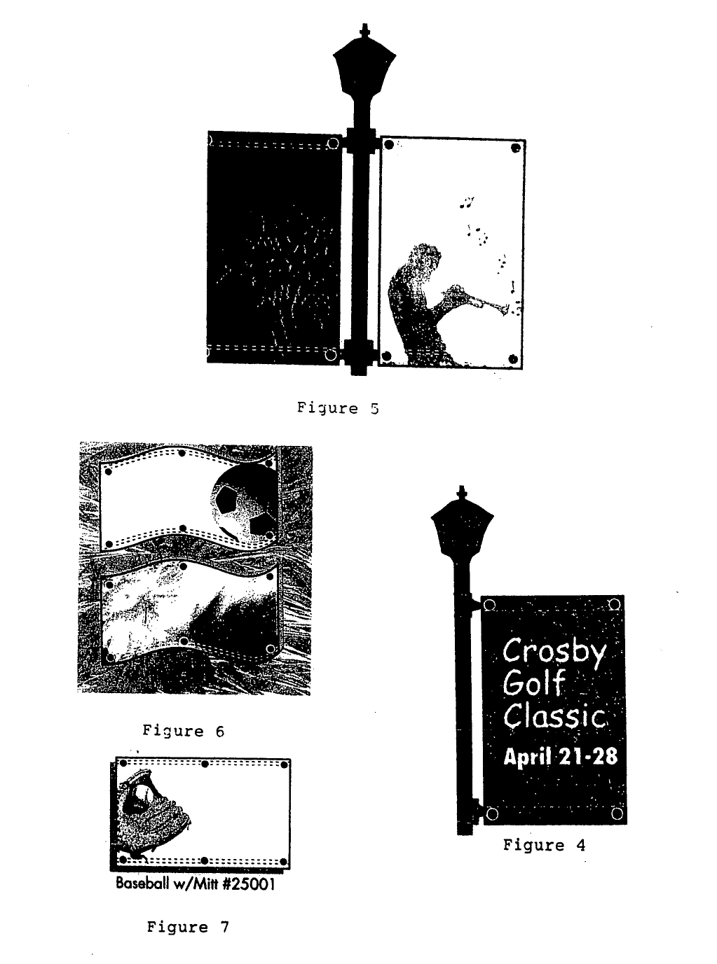

The present invention utilizes color images viewed in library or catalogue form to print on signs in a choice of media with a selected finishing. The banner designated lo in FIG. 6 displays a baseball theme and includes hems 12 and grommets 14 as a finishing. It can be printed with outdoor durable inks for fade resistance and water fastness. Media include, but are not limited to, banner material, adhesive vinyl, canvas, paper, corrugated plastic, foam, trade show lexan and backlit media. Other finishings are mount to magnetic, contour cut (FIG. 5), ropes in hems and pole pockets (used in the banners shown in FIGS. 3 and 4).

The process of the invention is for preparing customized signage and includes the steps of: offering a selection of background image media which may include but not be limited to banner material, adhesive vinyl, canvas, paper, corrugated plastic, foam and trade show lexan; offering a selection of images from a library of images with themes such as textures, seasons, celebrations, food, music, sports and holidays; offering a selection of finishings from an inventory of finishings including, but not limited to, mount to magnetic, contour cuts, ropes in hems, hems and grommets and pole pockets; providing the selected image media in a condition to receive and retain the desired graphics, and applying the desired graphics on the selected background image with the selected finish.

The process may be carried out by the supplier of the background image, the graphics and text applying the selected graphics to the selected background image or having a contract printer or signmaker make that application.

The process of the present invention can be practiced, for example, by the supplier establishing a website on the Internet, and making available the background images, graphics and text so that a customer seeking customized signage can design the product at the website. Specifically, the invention here becomes an online process of creating custom banners and signs using internet software such as that designed by Graphic Productions, Inc. of Winston-Salem, N.C. and marketed under the designation PhotoBlanks. Special programming is utilized to effect online customization of images and to create a file and allow the file to be sent to an imaging center for printing. Through the programming, the customer can add text or graphics anywhere on the background image since there is no pre-determined location on the background image which must be used. The customer can change typestyles and colors online to customize. The customer may further customize by applying its own logos and graphics. In the present invention, no input or scanning device is used, since the supporting environment is the Internet.

In summary, the present invention has the user choosing from an image library of various backgrounds on line where the user adds graphics or text to customize the chosen background image. There is no predetermined location where graphics or text must be added. Once the customized image is created, it is proofed online and the digital file is sent to an imaging center for printing. The process of the present invention does not merge images but instead customizes background images online with user-defined text or graphics.

It is to be understood that the signage made by the process of the present invention are shown herein for illustrative purposes and do not represent all of the products capable of being made by such process. Other forms of display products may be provided by the media, design and finishing selection process described herein and still be within the inventive concept. It is intended that the invention be limited only by the scope of the appended claims rather than by the details of the form shown.

1. A process for preparing customized signs comprising the steps of: selecting a media background image from a library of background images; adding selected graphics and text from an inventory of different graphics and text to the selected media background image; offering a selection of finishings from an inventory of finishings; providing the selected image finished media in a condition to receive and retain the selected graphics and text; and adding the selected graphics and text to the selected media background image to form a customized background image.

2. The process as claimed in claim 1 wherein the selected graphics and text are applied to the background image media by the party selecting the background image media.

3. The process as claimed in claim 1 wherein the selected graphics and text are applied to the background image media by the party furnishing the background image media.

4. The process as claimed in claim 1 wherein the selected media, image and finishing are printed with a color printer.

5. The process as claimed in claim 2 wherein the selected media, image and finishing are printed with a color printer.

6. The process as claimed in claim 3 wherein the selected media, image and finishing are printed with a color printer.

7. The process as claimed in claim 1 wherein the background design is in color.

8. The process as claimed in claim 2 wherein the background design is in color.

9. The process as claimed in claim 3 wherein the background design is in color.

10. The process as claimed in claim 1 wherein media is suitable for outdoor use.

11. The process as claimed in claim 2 wherein the media is suitable for outdoor use.

12. The process as claimed in claim 3 wherein the media is suitable for outdoor use.

13. A process for preparing customized signs comprising the steps of: selecting a media background image from a library of background images; adding selected graphics and text from an inventory of different graphics and text to the selected background image media; offering a selection of finishings from an inventory of finishings; providing the selected image finished media in a condition to receive and retain the selected graphics and text; and adding the selected graphics and text to the selected background image to form a customized background image wherein the media includes banner material, adhesive vinyl, canvas, paper, corrugated plastic, foam, and trade show lexan, the finishing includes mount to magnetic, contour cut, ropes in hems, hems and grommets and pole pockets, and the images include full background, ghosted center, fully ghosted, and white center.

14. The process as claimed in claim 13 wherein the selected graphics and text are applied to the background image media by the party selecting the background image media, the media includes banner material, adhesive vinyl, canvas, paper, corrugated plastic, foam, and trade show lexan, the finishing includes mount to magnetic, contour cuts, ropes in hems, hems and grommets and pole pockets and the images include full background, ghosted center, fully ghosted and white center.

15. The process as claimed in claim 14 wherein the selected graphics and text are applied to the background imaging media by the party furnishing the background image media, the media includes banner material, adhesive vinyl, canvas, paper, corrugated plastic, foam, and trade show lexan, the finishing includes mount to magnetic, contour cuts, ropes in hems, hems and grommets and pole pockets and the images include full background, ghosted center, fully ghosted center and white center.

16. The process as claimed in claim 13 wherein the selected graphics is printed with a color printer and the selected media is suitable for outdoor use.

17. The process as claimed in claim 14 wherein the selected graphics is printed with a color printer and the selected media is suitable for outdoor use.

18. The process as claimed in claim 15 wherein the selected graphics is printed with a color printer and the selected media is suitable for outdoor use.
